(19) United States
(12) Patent Application Publication
(10) Pub. No.: US 2012/0091737 A1
(43) Pub. Date: Apr. 19, 2012

(54) Earthquake Cabinet Safety

(76) Inventor: Joseph Conley, Palm Desert, CA (US)

(21) Appl. No.: 12/905,979

(22) Filed: Oct. 15, 2010

(51) Int. Cl. E05C 3/06

(52) U.S. Cl. 292/195

(57) ABSTRACT

Apparatus for detecting the initial shock of an earthquake and automatically locking a cabinet door before the occurrence of destructive ground motions having an accelerometer located to measure the acceleration of a shock wave of an earthquake coupled to an integrator which obtains the time integral of the acceleration of the shock wave of the earthquake. Comparing means which is coupled to the integrator to compare the value of the time integral of the acceleration of the shock wave with a preset value sends a signal to a signal generating means when the value of the time integral of the acceleration of the shock wave is equal or greater than the preset value. A power amplifier coupled to the signal generating means generates a signal which locks a cabinet door by operating a latch when the value of the time integral of the acceleration is equal or greater than the preset value.

### BACKGROUND OF THE INVENTION

1. Field of the Invention

The present invention relates to a method and apparatus for detecting the initial acceleration due to an earthquake and automatically locking a cabinet door before the-acceleration causes the cabinet or its contents to move more than an insignificant distance, for example 0.1 inch for a 10 g shock with a rise time of 0.01 second.

2. Description of Related Art

Latches for automatically locking cabinet doors during the occurrence of an earthquake is known in the prior art. More specifically, by way of example, U.S. PreGrant Pub. No. 2006/0279091 to Rhyneer discloses a lock that is actuated by an earthquake for locking a door of a compartment or other enclosure. A magnet can be embedded on an inside surface of a door of the compartment. A displaceable component is provided within the compartment. An earthquake force can displace a position of the displaceable component such that it can be aligned with the magnet. The displaceable component can be attracted to the magnet and thereby lock the door in a closed position.

U.S. Pat. No. 5,312,143 to Buckner discloses a tremor actuated cabinet door latch which has a spring loaded arm held back by a weighted trip pin. The pin releases the arm in response to shaking of the cabinet, allowing the arm to engage a catch mounted on the cabinet door, to keep the door from swinging open during an earth tremor.

U.S. Pat. No. 5,307,699 to Engdahl discloses an acceleration responsive magnetic device for closing a valve or operating a switch or the like in response to a disturbance such as an earthquake. A pendulum operates to increase the length of a magnetic path, releasing a magnetic element to perform the desired actuation.

U.S. Pat. No. 5,597,188 to Miche discloses a latching device which detects the initial shocks of major earthquakes and activates safety devices before the onset of destructive ground motions. A unidirectional vertical threshold seismoscope is integrated with mechanical and electromechanical safety devices to latch cabinets closed, secure movable objects, shut off gas, water, and electric utilities, activate alarms, early warning networks, and related automated response systems. The device is fully self contained, requires no external power, and is virtually impervious to non-earthquake noise in that it is designed to respond specifically to the vertical acceleration and displacement characteristic of the initial shock waves of a major earthquake.

U.S. Pat. No. 5,152,562 to Stevenson discloses a shock-activated lock for attachment to a cabinet that prevents the cabinet door from opening in the event of an earthquake. The lock includes a slotted engaging member attached to the cabinet door, and a lock housing attached to the cabinet frame that contains a ball that normally rests on a raised shelf. The engaging member extends into the housing when the door is closed. In the event of an earthquake, the ball falls into the slot in the engaging member, preventing the engaging member from withdrawing from the housing, thus preventing the cabinet door from opening.

U.S. Pat. No. 6,866,312 to Rhyneer discloses a lock for earthquakes that securely holds a door closed when an earthquake strikes, but it otherwise out of the way during normal use. It consists of a steel ball that is positioned at the top of an angled ramp. A magnet is embedded on the inside surface of the door, where it is invisible under normal use. When an earthquake strikes, the steel ball drops and contacts the magnet. At this point, the door is effectively locked. The system is designed so that the magnet is strong enough to securely hold the door closed, but can be easily overcome to open the door after the event is over.

U.S. Pat. No. 5,611,579 to Kreitenberg discloses a cabinet mounted latch activated by the movements of an earthquake from a ready position. The latch then engages a door mounted hook to prevent door opening. The device may be manually activated or inactivated to provide on demand childproofing or unobstructed door use.

U.S. Pat. No. 5,570,914 to Hughes discloses an earthquake actuated door latch that mounts outside a cabinet or beside the cabinet door. The device contains a pivoted catch assembly with a weight on one end and a door catch, or hook, on the other. The catch assembly is stable in two positions, one on each side of the cabinet door. An earth tremor causes the weight to shift out of the cocked position to the operated position (the second stable position) putting the hook where it interferes with opening of the cabinet door. Weight and hook move as a unit, minimizing delay, and an internal lock prevents rebound.

U.S. Pat. No. 5,529,352 to Chin discloses a latch responsive to inertial movement of a structure for locking a closure during an earthquake. The device includes a base plate mountable to the interior structure of a cabinet or the like. A latch is pivotally mounted at a lower end thereof to the base plate and projects upward to rest against a guide pin. A hook is mounted to the interior of the cabinet door such that movement of the cabinet during an earthquake will cause the latch to fall into engagement with the hook to lock the cabinet door shut.

U.S. Pat. No. 5,664,815 to Kornder discloses a safety device for securing dual adjacent cabinet doors, each having a door handle or door knob. The safety device is made of a single rigid rod made of substantially inflexible, durable material, forming an elongated arm with perpendicularly depending legs with tip ends covered by resilient enlargements.

U.S. Pat. No. 5,742,235 to Miche discloses a switch including a mass suspended above a base by a flat horizontal spring which has electric contacts that close in response to the initial shocks of major earthquakes and activates safety devices before the onset of destructive ground motions. The vertical unidirectional seismic switch can be manufactured by micromechanical photolithography and is integrated with electromechanical safety devices to latch cabinets closed. The device is fully self contained is designed to respond specifically to the vertical acceleration and displacement characteristic of the initial shock waves of a major earthquake.

U.S. Pat. No. 5,697,655 to Strong discloses a ball operated, automatic vibration safety latching device including a cantilevered arm which is gravity biased to a radial position to leave a catch normally disengaged, a ball positioned atop a ball support, and a retaining cup attached to the arm and arranged beneath the ball support. Any undue vibration such as that caused by an earthquake or nearby explosion will dislodge the ball causing the ball to drop into the retaining cup which will cause the cantilevered arm to rotate around its pivot so as to then engage the catch or otherwise block the door. A single latching device may be used with two catches to serve two doors or other items that need to be restrained.

### SUMMARY OF THE INVENTION

In an exemplary embodiment of the present invention, there is disclosed apparatus for detecting the initial acceleration due to an earthquake and automatically locking a cabinet door before the occurrence of destructive ground motions. An accelerometer is attached to the cabinet itself (or to an alternative point) and determines the acceleration due to the earthquake within 0.05 seconds. This signal is doubly integrated to determine the transient motion of the cabinet. The resulting signal is compared to a predetermined threshold. If that threshold is exceeded a signal is propagated to an amplifier that operates a mechanism (typically a solenoid) for locking the cabinet. This operation is completed within a few milliseconds. Note that none of the prior art specifies a quantitative measure of its performance. The cabinet can be unlocked at a convenient time by closing a mechanical switch.

The more important features of the invention have been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow diagram of at least one triaxial accelerometer being used to determine the magnitude of acceleration and the time integral of the acceleration due to an earthquake and, when the magnitude of the double integral of the measured acceleration exceeds a preset value, initiate a signal which operates the cabinet door latch before appreciable motion of the contents within a cabinet may occur in accordance with the principles of the invention.

### DESCRIPTION OF THE PREFERRED EMBODIMENT

In a typical earthquake that causes moderate structural damage, delicate objects are damaged not directly by the earthquake vibrations, but by falling to the floor when the cabinet in which they are stored is not locked closed.

This invention is directed toward protecting delicate objects from damage due to an earthquake by locking cabinet doors before the destructive acceleration of an earthquake shakes the cabinet appreciably. The invention incorporates one triaxial accelerometer to determine the magnitude of the acceleration due to the earthquake and, from this information, the value of the double time integral of the acceleration is determined using electrical components. When the determined value of the time integral of the acceleration exceeds a preset value, a signal is generated which activates any number of rapid-acting latches coupled to lock the door(s) of a cabinet which have valuable items that are susceptible of damage form falling.

One of the primary hazards which is associated with an earthquake is the shaking or displacement of the ground which is a vector which has both horizontal and vertical components. The second derivative of this displacement is the acceleration. Acceleration can be measured using an accelerometer. Thus, an accelerometer is a device that measures the acceleration of motion of a structure such as a building. In one type of an accelerometer the force caused by the vibration or a change in motion (acceleration) causes a mass in the accelerometer to “squeeze” a piezoelectric material which then produces an electrical charge that is proportional to the force exerted upon it. Since the charge is proportional to the force, and the mass is a constant, the charge is also proportional to the acceleration.

In the invention the vectors of an earthquake are measured with three accelerometers normally contained is a single housing which measure three orthogonal axes. The three accelerometers are normally located in a common housing which is marked to show how the accelerometer is to be positioned.

The output signal of the accelerometer is used to obtain the value of the time integral of the acceleration which is examined to determine if it is equal to or greater than a preset level. If the obtained value is equal to or greater that a preset level, a signal is generated which is fed to a power amplifier which operates a latch to lock a cabinet door before any appreciable motion of the contents within the cabinet may occur.

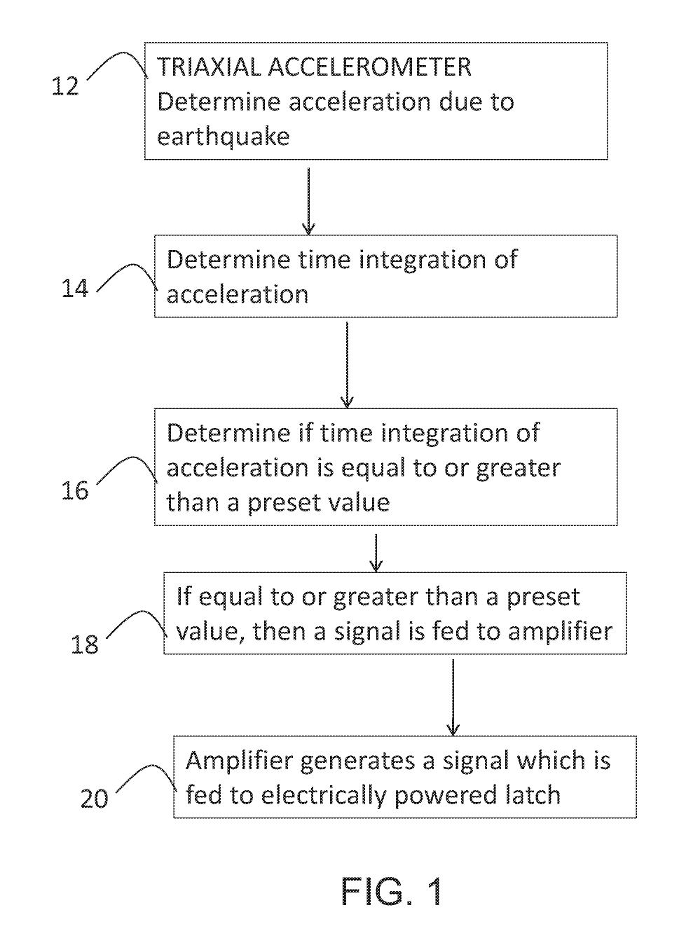

Referring to FIG. 1, there is shown a flow diagram where a triaxial accelerometer is used to determine the magnitude of acceleration from which the time integral of the acceleration is obtained and, when the magnitude of the time integral of the acceleration exceeds a preset value, a signal is generated which operates to latch a cabinet door before any appreciable motion of the contents may occur in accordance with the principles of the invention.

On the occurrence of an earthquake an accelerometer generates a signal which is proportional to the acceleration due to the earthquake, block 12. The signal generated is fed to block 14 where a signal of the time integration of the acceleration is obtained. The signal of the time integration of the acceleration is compared to a signal having a preset value to determine if the signal of the time integration of the acceleration is equal to or greater than the signal having the preset value, block 16. If it is determined that the signal of the time integration of the acceleration is equal to or greater than the signal having the preset value, block 18, a signal is generated which is fed to a power amplifier, block 20. The power amplifier, upon receiving a signal which indicates that the signal of the time integration of the acceleration is equal to or greater than the preset signal generates a signal of sufficient power to operate a latch to lock the door of a cabinet containing delicate items.

In use, the accelerometer can be located in the cabinet, attached to the outside of the cabinet, located on the floor of the building adjacent to the cabinet, on a foundation support or footing of the building, or on a support that is embedded in the ground in the basement of the building. Regardless of where the accelerometer is located it should be firmly anchored to its support member with screws, an adhesive such as an epoxy or any convenient anchoring means.

The accelerometer, the components for determining the time integral of the acceleration and its value relative to a preset value, the power amplifier and, if required, the solenoid and/or latch can be powered from a battery. The average power requirement of the device is such that it can be operated by a long life primary battery. No connection to a utility company's 117 volt source of power is required. When desired, the cabinet door can be unlocked and opened manually.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method for detecting the initial acceleration due to an earthquake and automatically locking a cabinet door before the occurrence of destructive ground motions comprises:
locating an accelerometer to measure the acceleration due to an earthquake;
obtaining the time integral of the acceleration of the shock wave of the earthquake;
comparing the value of the time integral of the acceleration of the shock wave with a preset value;
generating a signal when the value of the time integral of the acceleration of the shock wave is equal or greater than the preset value; and
locking a cabinet door by operating a latch when the value of the time integral of the acceleration is equal or greater than the preset value.

2. The method of claim 1 wherein the accelerometer is a triaxial accelerometer.

3. The method of claim 2 wherein the accelerometer is attached to the cabinet.

4. The method of claim 2 wherein the accelerometer is located on the floor of the building adjacent to the cabinet.

5. The method of claim 2 wherein the accelerometer is located on a foundation support or footing of the building which includes the cabinet.

6. The method of claim 2 wherein the accelerometer is located on a support that is embedded in the ground in the basement of the building which includes the cabinet.

7. The method of claim 2 wherein the latch includes a solenoid.

8. The method of claim 2 wherein the latch is a spring powered latch.

9. Apparatus for detecting the initial acceleration due to an earthquake and automatically locking a cabinet door before the occurrence of destructive ground motions comprising:
an accelerometer located to measure the acceleration due to an earthquake;
an integrator coupled to the accelerometer to obtain the time integral of the acceleration of the shock wave of the earthquake;
comparing means coupled to the integrator to compare the value of the time integral of the acceleration of the shock wave with a preset value;
signal generating means coupled to the comparing means to generate a signal when the value of the time integral of the acceleration of the shock wave is equal or greater than the preset value; and
a power amplifier coupled to the signal generating means to generate a signal which locks a cabinet door by operating a latch when the value of the time integral of the acceleration is equal or greater than the preset value.

10. The apparatus of claim 9 wherein the accelerometer is a triaxial accelerometer.

11. The apparatus of claim 10 wherein the accelerometer is attached to the cabinet.

12. The apparatus of claim 10 wherein the accelerometer is located on the floor of the building adjacent to the cabinet.

13. The apparatus of claim 10 wherein the accelerometer is located on a foundation support or footing of the building which includes the cabinet.

14. The apparatus of claim 10 wherein the accelerometer is located on a support that is embedded in the ground in the basement of the building which includes the cabinet.

15. The apparatus of claim 10 wherein the latch includes a solenoid.

16. The apparatus of claim 10 wherein the latch is a spring powered latch.
